(19) United States
(12) Patent Application Publication
(10) Pub. No.: US 2012/0296598 A1
(43) Pub. Date: Nov. 22, 2012

(54) COMPENSATING FOR JITTER DURING DDR3 MEMORY DELAY LINE TRAINING

(75) Inventors: Craig R. Chafin, Colorado Springs, CO (US); William J. Schmitz, Monument, CO (US); Carl E. Gygi, Colorado Springs, CO (US)

(73) Assignee: LSI CORPORATION, Milpitas, CA (US)

(21) Appl. No.: 13/110,049

(22) Filed: May 18, 2011

(51) Int. Cl. G06F 19/00

(52) U.S. Cl. 702/125

(57) ABSTRACT

A method for compensating for jitter during DDR3 delay line training may include using a computer or processor to perform the steps of executing a plurality of tests for each one of a plurality of delay values for an interconnect delay between a Double-Data-Rate Three (DDR3) memory controller and a DDR3 Synchronous Dynamic Random Access Memory (SDRAM); accumulating a plurality of test results for each plurality of tests for each one of the plurality of delay values; determining a plurality of final test results, where each final test result is associated with an accumulated plurality of test results; and determining a working window edge for the interconnect delay between the DDR3 memory controller and the DDR3 SDRAM utilizing the plurality of final test results.

### TECHNICAL FIELD

The present disclosure generally relates to the field of electronic data storage, and more particularly to a method and computer program product for compensating for jitter during DDR3 delay line training.

### BACKGROUND

When a system that uses Double-Data-Rate Three (DDR3) Synchronous Dynamic Random Access Memory (SDRAM) is powered on, the interface must be trained so that read and write cycles function synchronously without corrupting data. DDR3 systems are highly configurable and capable of varying clock frequency, voltage, device rank, geometry, bus width, error correction code, buffering, and size. To accommodate this flexibility, the interconnect delay between the memory controller and the SDRAMs may be determined in an algorithmic fashion. Unless some of the flexibility of the memory is removed, this training requires a process of trial and error until a working combination is found.

Generally, training algorithms use a simple one-pass exhaustive search. All combinations of write and read delay settings are attempted (either simultaneously or independently) until a working range of values is found. Then, one particular value is selected to represent the optimal data eye. Depending on the algorithm, this is typically the mathematical average located in the middle of the working range. This average value is then programmed into the delay registers to complete the training sequence.

Current training algorithms focus on minimizing the duration of DDR3 initialization. To simplify data transfers, only a minimum number of beats are examined. It is assumed that each unique delay combination consistently results in either a pass or fail result. Thus, each delay combination is only examined once to find the center of the eye. These algorithms do not work in systems with high levels of jitter due to complex Printed Circuit Board (PCB) layout discontinuities that occur with vias, bends in traces and serpentine delay lines, non-standard Joint Electron Devices Engineering Council (JEDEC) DRAM topologies, or power supply droop due to Simultaneous Switching Noise (SSN) variations. Thus, when jitter exists in a system, it is not mitigated. This may result in an inaccurate data eye center, possibly pushing Process, Voltage, and Temperature (PVT) compensation circuitry beyond functional limits, causing training failures in the field, or causing data corruption.

### SUMMARY

A method for compensating for jitter during DDR3 delay line training may include using a computer or processor to perform the steps of executing a plurality of tests for each one of a plurality of delay values for an interconnect delay between a Double-Data-Rate Three (DDR3) memory controller and a DDR3 Synchronous Dynamic Random Access Memory (SDRAM); accumulating a plurality of test results for each plurality of tests for each one of the plurality of delay values; determining a plurality of final test results, where each final test result is associated with an accumulated plurality of test results; and determining a working window edge for the interconnect delay between the DDR3 memory controller and the DDR3 SDRAM utilizing the plurality of final test results.

A method for compensating for jitter during DDR3 delay line training may include using a computer or processor to perform the steps of executing a plurality of tests for each one of a plurality of delay values for an interconnect delay between a Double-Data-Rate Three (DDR3) memory controller and a DDR3 memory; accumulating a first plurality of test results for each plurality of tests for each one of the plurality of delay values; determining a first plurality of final test results, where each final test result is associated with an accumulated plurality of test results; determining a first working window edge for the interconnect delay between the DDR3 memory controller and the DDR3 memory utilizing the first plurality of final test results; adjusting at least one attribute of the DDR3 memory controller or the DDR3 memory; accumulating a second plurality of test results for each plurality of tests for each one of the plurality of delay values; determining a second plurality of final test results associated with the accumulated second plurality of test results; and determining a second working window edge for the interconnect delay between the DDR3 memory controller and the DDR3 memory utilizing the second plurality of final test results. The first working window edge and the second working window edge may be compared, and the at least one attribute of the DDR3 memory controller or the DDR3 memory may be selected based upon the comparison to maximize jitter tolerance for the DDR3 memory.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 is a flow diagram illustrating a method for compensating for jitter during DDR3 delay line training;

FIG. 2 is a flow diagram illustrating accumulating pass/fail test results for various delay values;

FIG. 3 is a flow diagram illustrating determining final test results based upon the accumulated pass/fail test results for the various delay values;

FIG. 4 is a flow diagram illustrating determining working window edges based upon the final test results for the various delay values;

FIG. 5 is a chart illustrating a series of accumulated test results for various delay line values for detecting the earliest rising edge of a clock utilizing a write-leveling algorithm;

FIG. 6A is a chart illustrating a series of accumulated test results for various delay line values for detecting a true window edge boundary when jitter is present;

FIG. 6B is an expanded view of a portion of the chart illustrated in FIG. 6A; and

FIG. 7 illustrates a computer program product related to executing a set of tests for each one of a number of delay values for an interconnect delay between a DDR3 memory controller and a DDR3 SDRAM; accumulating a set of test results for each set of tests for each one of the various delay values; determining a number of final test results, where each final test result is associated with an accumulated set of test results; and determining a working window edge for the interconnect delay between the DDR3 memory controller and the DDR3 SDRAM utilizing the final test results.

### DETAILED DESCRIPTION

Reference will now be made in detail to the subject matter disclosed, which is illustrated in the accompanying drawings.

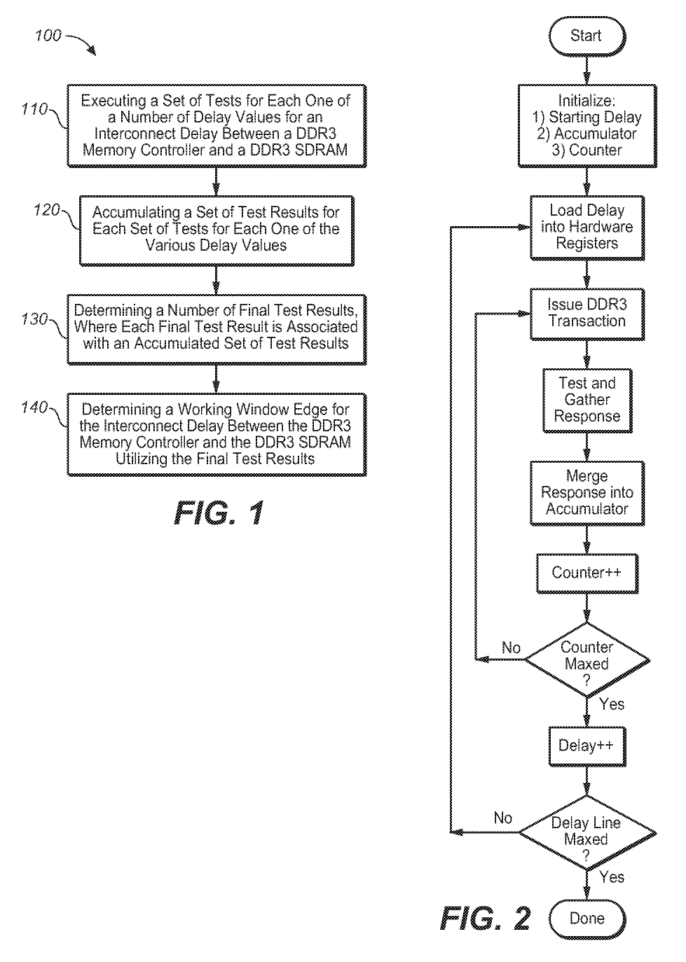

Referring generally to FIGS. 1 through 7, a method and computer program product for compensating for jitter during DDR3 delay line training is described. The present disclosure may be utilized with delay training for DDR3 memory controllers to ensure that read and write cycles work properly. An enhanced training algorithm is provided that allows firmware to detect jitter boundaries and compensate for various board layout and Dual In-line Memory Module (DIMM) combinations. In one instance, the results of each test may be accumulated together such that if any one bit failed, the overall delay combination is marked as failed. For example, a particular delay combination may pass 75 times out of 100 iterations, but due to clock jitter in the system, should really be considered a failure. If a one-pass algorithm was utilized, it could be fooled most of the time. The multi-pass algorithm of the present disclosure filters out these undesirable delay values.

Jitter may also cause inconsistent data eye widths. Utilizing data from the accumulated final results, the eye window can be “narrowed-in” (or otherwise adjusted) to ensure the true eye center is found. The number of iterations for the accumulator and eye window consistency check can be determined from lab clock jitter validation analysis using an oscilloscope. Once the jitter value is determined for the system, it may be translated into a value for the production algorithm. It should be noted that trade-offs can be made during validation between jitter tolerance levels and algorithm run time.

For example, a greater number of iterations may provide a more accurate eye window at the expense of a longer run time.

A method 100 may include executing a set of tests for each one of a number of delay values for an interconnect delay between a DDR3 memory controller and a DDR3 SDRAM, 110. For example, a pass or fail test may be executed multiple times for each delay value. In some implementations, all possible delay values may be attempted rather than coarse steps. The method 100 may also include accumulating a set of test results for each set of tests for each one of the various delay values, 120. In embodiments, an accumulator may be implemented as a unique storage element per delay value. Each delay value can be attempted several times, and the result is merged in the accumulator (e.g., as described in FIG. 2). The merge may be implemented such that each result is represented. In implementations, a pass or fail moniker may be utilized to symbolize test results whether for a standard JEDEC digital response, or data payload integrity.

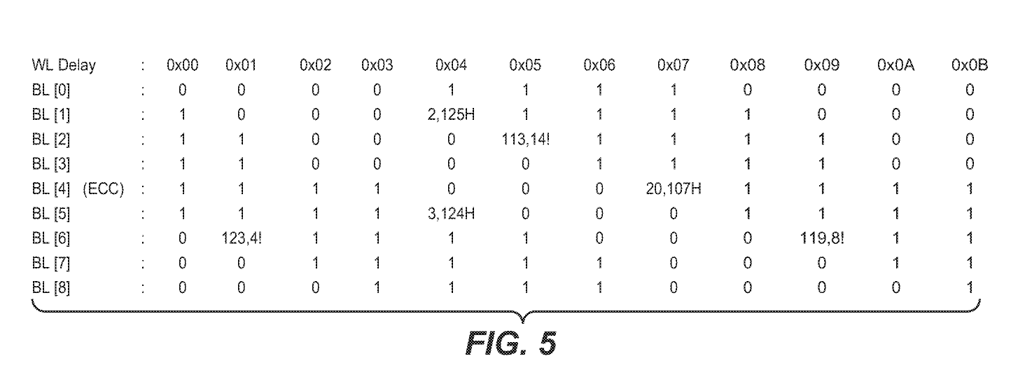

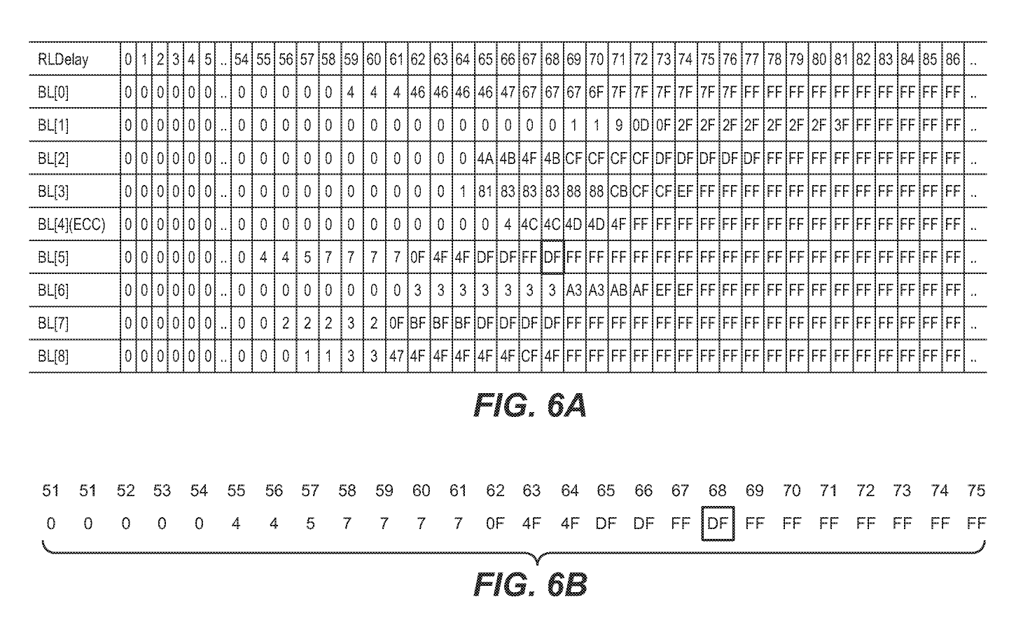

In the example described in FIG. 5, where the test is looking for a logical binary response, the accumulator may count the total number of zeros (failures) and total number of ones (passes) for each delay trial. In this instance, it may be observed whether the zero or one response is consistent. In the example described in FIGS. 6A and 6B, where the test is looking for any one bit to fail in an expected 0xFF byte lane response, the accumulator may be implemented as the logical AND of each response. In this scenario, if any bit is ever a zero during the iterations, the accumulator may save this information for interpretation later. It should be noted that the accumulator may be utilized in any training algorithm or sequence including, but not limited to, write leveling, gate training, pre-amble finder, and/or read-eye training.

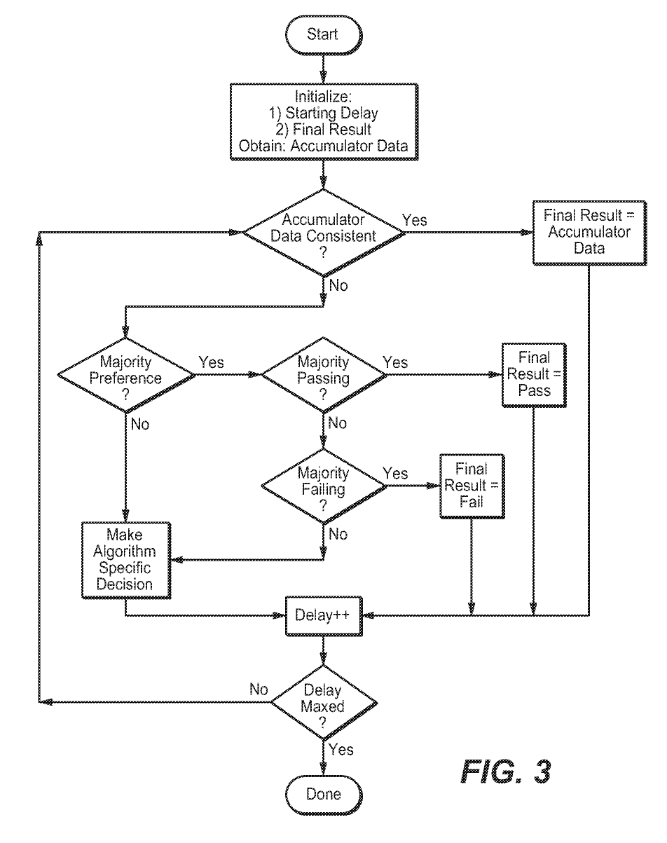

The method 100 may further include determining a number of final test results, where each final test result is associated with an accumulated set of test results, 130. Once the accumulator data is obtained, it may be analyzed in an algorithmic way to determine a final result (e.g., as described in FIG. 3). When all of the accumulator data is consistent (e.g., all ones/passes or all zeroes/fails), the decision for the final result may be straightforward. However, if the data is not consistent, as is often the case in a high speed DDR environment, a decision can be made about the results. In a case where it is acceptable to utilize the greater count (majority) of the two responses, the final result may be the larger majority. However in a case where it is not acceptable to utilize the majority, or when a majority cannot be determined (e.g., when the pass and fail counts are the same), an algorithm specific decision can be made.

For example, the chart of FIG. 5 describes a write-leveling algorithm utilizing the standard JEDEC response, at DDR3-1333 speed (667 MHz), with an accumulator tracking 127 trials. In FIG. 5, the top row represents delay values, and the leftmost column represents byte lanes with an Error Correction Code (ECC) check-byte in the middle. For delay=0x0 on byte lane 0 (BL[0]), the response was “0” for all 127 trials. For delay =0x1 on byte lane 2 (BL[2]), the response was “1” for all 127 trials. These are examples of a straightforward case. For delay=0x4 on byte lane 1 (BL[1]), the response was “0” two times, and “1” 125 times. The “H” signifies that the final result was interpreted as a “1” by majority preference (e.g., there were more “1” responses than “0” responses). For delay=0x5 on byte lane 2, the response was “0” 113 times, and “1” 14 times. In this case a special algorithmic decision was made (signified by the exclamation point).

Because this example illustrates a write-leveling algorithm where the goal is to detect the earliest rising edge of the clock (to ensure proper setup time), this value was interpreted as a “1” even though it only appeared a few times compared to “0”. This example shows how utilizing an accumulator allows for finding a correct response with jitter present in the system. The above-described process then continues until all accumulator results are analyzed for each delay value and processed into a final result. It should be noted that the processing of accumulator values into final results is not specific to write leveling, but can be used in any of the DDR3 related training algorithms.

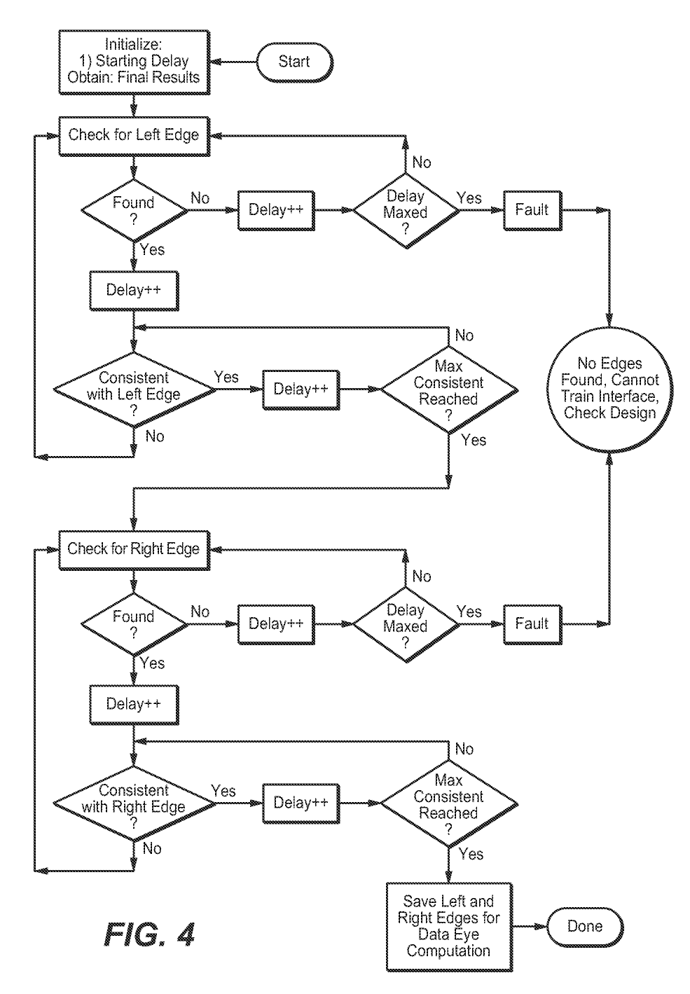

The method 100 may further include determining a working window edge for the interconnect delay between the DDR3 memory controller and the DDR3 SDRAM utilizing the final test results, 140. Once the final results are obtained from the accumulator, the next step is to determine the raw edges of the working window (e.g., as illustrated in FIG. 4). This may be accomplished by searching for transitions in the final data for each delay value starting at the minimum and stopping at the maximum. First the search looks for a left edge, and, once found, verifies the next several delay steps are consistent. If they are consistent, everything is ok; otherwise the edge is moved in to compensate for jitter. Second the search looks for a right edge and repeats the same consistency check. For example, the chart of FIGS. 6A and 6B describes consistency checks to ensure the found edge is a true boundary. Due to jitter, it may be possible that delay settings immediately near a detected edge are marginal. For example, in FIG. 6, a left edge is detected at a delay of 67. The next delay of 68 shows that one bit failed. Therefore, to compensate for jitter and ensure optimal data eye, the edge should be moved right to 69 in this example.

It should be noted that method 100 may be applied to any DDR3 delay line training steps, including, but not limited to, write leveling, pre-amble finder, gate training, and/or read-leveling. Further, method 100 may be repeated multiple times as DDR3 memory controller and/or DDR3 memory attributes are changed. For example, the driver slew rate and termination may be dynamically changed between iterations of method 100 to achieve further jitter tolerance. The resulting data may then be merged into the accumulator to achieve data eye window consistency. In other embodiments, jitter tolerance may be further improved at the expense of system performance. In a specific implementation, to maximize jitter tolerance that works around Simultaneously Switching Noise (SSN), system performance may be sacrificed. For example, when the tCCD parameter (representing command to command delay) is slowly increased, the effective traffic time may be slowed, reducing noise and power supply draw at the expense of longer transfer times.

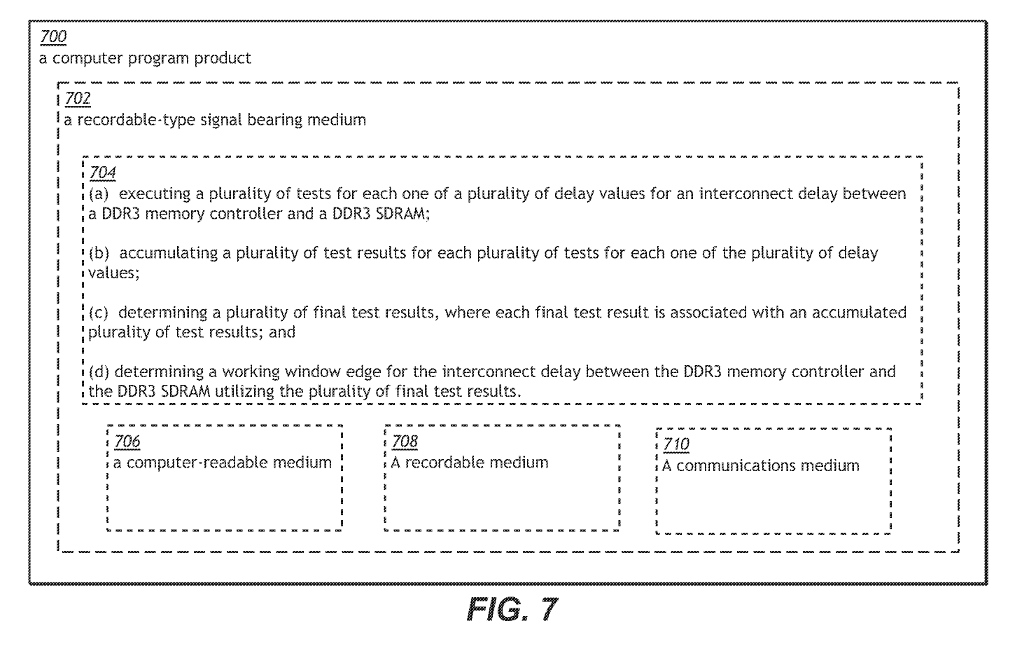

FIG. 7 illustrates a partial view of an example computer program product 700 that includes a computer program 704 for executing a computer process on a computing device. An embodiment of the example computer program product 700 is provided using a recordable-type signal bearing medium 702, and may include computer usable code configured for executing a plurality of tests for each one of a plurality of delay values for an interconnect delay between a DDR3 memory controller and a DDR3 SDRAM. The computer program product may also include a recordable-type signal bearing medium bearing computer usable code configured for accumulating a plurality of test results for each plurality of tests for each one of the plurality of delay values. The computer program product may include a recordable-type signal bearing medium bearing computer usable code configured for determining a plurality of final test results, where each final test result is associated with an accumulated plurality of test results. The computer program product may include a recordable-type signal bearing medium bearing computer usable code configured for determining a working window edge for the interconnect delay between the DDR3 memory controller and the DDR3 SDRAM utilizing the plurality of final test results. The computer usable code may be, for example, computer executable and/or logic-implemented instructions. In one implementation, the signal-bearing medium 702 may include a computer-readable medium 706. In one implementation, the signal bearing medium 702 may include a recordable medium 708. In one implementation, the signal bearing medium 702 may include a communications medium 710.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In one embodiment, several portions of the subject matter described herein can be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one skilled in the art in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a non-transitory signal bearing medium include, but are not limited to, the following: a recordable type medium such as a floppy disk, a hard disk drive, a Compact Disc (CD), a Digital Video Disk (DVD), a digital tape, a computer memory, and the like; and a transmission type medium such as a digital and/or an analog communication medium (e.g., a fiber optic cable, a waveguide, a wired communications link, a wireless communication link (e.g., transmitter, receiver, transmission logic, reception logic, and the like), and the like).

In the present disclosure, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

What is claimed is:

1. A method, comprising:
using a computer or processor to perform the steps of:
executing a plurality of tests for each one of a plurality of delay values for an interconnect delay between a Double-Data-Rate Three (DDR3) memory controller and a DDR3 Synchronous Dynamic Random Access Memory (SDRAM);
accumulating a plurality of test results for each plurality of tests for each one of the plurality of delay values;
determining a plurality of final test results, where each final test result is associated with an accumulated plurality of test results; and
determining a working window edge for the interconnect delay between the DDR3 memory controller and the DDR3 SDRAM utilizing the plurality of final test results.

2. The method of claim 1, wherein each accumulated plurality of test results represents each test result.

3. The method of claim 1, wherein each accumulated plurality of test results represents the logical AND of each test result, where each test results is represented in binary.

4. The method of claim 1, wherein each accumulated plurality of test results represents the greater count of the test results.

5. The method of claim 1, wherein the interconnect delay between the DDR3 memory controller and the DDR3 SDRAM is implemented for at least one of write leveling, read leveling, gate training, pre-amble finding, or read-eye training.

6. The method of claim 1, further comprising:
adjusting at least one attribute of the DDR3 memory controller or the DDR3 SDRAM;
accumulating a second plurality of test results for each plurality of tests for each one of the plurality of delay values;
determining a second plurality of final test results associated with the accumulated second plurality of test results; and
determining a second working window edge for the interconnect delay between the DDR3 memory controller and the DDR3 SDRAM utilizing the second plurality of final test results.

7. The method of claim 6, wherein adjusting at least one attribute of the DDR3 memory controller or the DDR3 SDRAM comprises:
adjusting the driver slew rate and termination for the DDR3 SDRAM.

8. A method, comprising:
using a computer or processor to perform the steps of:
executing a plurality of tests for each one of a plurality of delay values for an interconnect delay between a Double-Data-Rate Three (DDR3) memory controller and a DDR3 memory;
accumulating a first plurality of test results for each plurality of tests for each one of the plurality of delay values;
determining a first plurality of final test results, where each final test result is associated with an accumulated plurality of test results;
determining a first working window edge for the interconnect delay between the DDR3 memory controller and the DDR3 memory utilizing the first plurality of final test results;
adjusting at least one attribute of the DDR3 memory controller or the DDR3 memory;
accumulating a second plurality of test results for each plurality of tests for each one of the plurality of delay values;
determining a second plurality of final test results associated with the accumulated second plurality of test results; and
determining a second working window edge for the interconnect delay between the DDR3 memory controller and the DDR3 memory utilizing the second plurality of final test results, where the first working window edge and the second working window edge are compared, and the at least one attribute of the DDR3 memory controller or the DDR3 memory is selected based upon the comparison to maximize jitter tolerance for the DDR3 memory.

9. The method of claim 8, wherein each accumulated plurality of test results represents each test result.

10. The method of claim 8, wherein each accumulated plurality of test results represents the logical AND of each test result, where each test results is represented in binary.

11. The method of claim 8, wherein each accumulated plurality of test results represents the greater count of the test results.

12. The method of claim 8, wherein the interconnect delay between the DDR3 memory controller and the DDR3 memory is implemented for at least one of write leveling, read leveling, gate training, pre-amble finding, or read-eye training.

13. The method of claim 8, wherein adjusting at least one attribute of the DDR3 memory controller or the DDR3 memory comprises:
adjusting the driver slew rate and termination for the DDR3 memory.

14. A computer program product, comprising:
a recordable-type signal bearing medium bearing computer usable code configured for executing a plurality of tests for each one of a plurality of delay values for an interconnect delay between a Double-Data-Rate Three (DDR3) memory controller and a DDR3 Synchronous Dynamic Random Access Memory (SDRAM);
a recordable-type signal bearing medium bearing computer usable code configured for accumulating a plurality of test results for each plurality of tests for each one of the plurality of delay values;
a recordable-type signal bearing medium bearing computer usable code configured for determining a plurality of final test results, where each final test result is associated with an accumulated plurality of test results; and
a recordable-type signal bearing medium bearing computer usable code configured for determining a working window edge for the interconnect delay between the DDR3 memory controller and the DDR3 SDRAM utilizing the plurality of final test results.

15. The computer program product of claim 14, wherein each accumulated plurality of test results represents each test result.

16. The computer program product of claim 14, wherein each accumulated plurality of test results represents the logical AND of each test result, where each test results is represented in binary.

17. The computer program product of claim 14, wherein each accumulated plurality of test results represents the greater count of the test results.

18. The computer program product of claim 14, wherein the interconnect delay between the DDR3 memory controller and the DDR3 SDRAM is implemented for at least one of write leveling, read leveling, gate training, pre-amble finding, or read-eye training.

19. The computer program product of claim 14, further comprising:
a recordable-type signal bearing medium bearing computer usable code configured for adjusting at least one attribute of the DDR3 memory controller or the DDR3 SDRAM;
a recordable-type signal bearing medium bearing computer usable code configured for accumulating a second plurality of test results for each plurality of tests for each one of the plurality of delay values;
a recordable-type signal bearing medium bearing computer usable code configured for determining a second plurality of final test results associated with the accumulated second plurality of test results; and
a recordable-type signal bearing medium bearing computer usable code configured for determining a second working window edge for the interconnect delay between the DDR3 memory controller and the DDR3 SDRAM utilizing the second plurality of final test results.

20. The computer program product of claim 19, wherein adjusting at least one attribute of the DDR3 memory controller or the DDR3 SDRAM comprises:
adjusting the driver slew rate and termination for the DDR3 SDRAM.
